(19) United States
(12) Patent Application Publication
(10) Pub. No.: US 2020/0048392 A1
(43) Pub. Date: Feb. 13, 2020

(54) PHYSICALLY CROSSLINKABLE (METH)ACRYLATE COPOLYMER COMPOSITION

(71) Applicant: 3M INNOVATIVE PROPERTIES COMPANY, St. Paul, MN (US)

(72) Inventors: Stefan H. Gryska, Woodbury, MN (US); Joon Chatterjee, Gaithersburg, MD (US); Deepti Gopalakrishnan, Jersey City, NJ (US); George W. Griesgraber, Eagan, MN (US); Larry R. Krepski, White Bear Lake, MN (US); Babu N. Gaddam, Woodbury, MN (US)

(21) Appl. No.: 16/485,576

(22) PCT Filed: Feb. 13, 2018
(86) PCT No.: PCT/US2018/017912

§ 371 Date: Aug. 13, 2019

Related U.S. Application Data
(60) Provisional application No. 62/460,340, filed on Feb. 17, 2017.

(51) Int. Cl. C08F 297/02; C08L 33/08; C08L 33/12; C08F 20/06

(52) U.S. Cl. CPC C08F 297/026; C08L 33/08; C08K 5/0025; C08F 20/06; C08L 33/12

(57) ABSTRACT

Described is a polymerizable polymer composition compri a) a copolymerizable macromer, b) a (meth)acrylate ester monomer; and c) a polyfunctional type I photoinitiator.

### BACKGROUND

Acrylic pressure sensitive adhesives (PSAs) have emerged as the product of choice in a variety of end-use applications where color, clarity, permanency, weatherability, versatility of adhesion, or the chemical characteristics of an all acrylic polymer is required. These applications include a variety of consumer, packaging, industrial and health care tapes, paper and film labels, decals, bumper stickers, and the like.

Normally tacky pressure-sensitive adhesive (“psa”) compositions suitable, for example, for use in adhesive tapes must have a requisite fourfold balance of adhesion, cohesion, stretchiness and elasticity. Psa coated tapes have been produced for at least a half a century. The expectation level of the performance of early psa coated tapes was, to say the least, not great. Early psa tapes were expected to at least temporarily adhere to the surface upon which they were adhered and certain minor problems such as adhesive failure, discoloration, cohesive failure, etc. were tolerated. As psas became more sophisticated, mainly because of research in this area, the expectation level of the performance of the psa on coated tapes reached an extremely high level.

Some psa compositions desirably have transparency and resistance to sunlight aging even on exposure to severe weather conditions. With environmental considerations being more important, solvent-free processability is also a desired but often elusive feature.

Many block copolymers have psa properties and have cohesive strength and hot melt processability, but they do not have the oxidative resistance or the optical clarity of the acrylic ester adhesives. Various references teach block copolymer psa compositions, but not how to improve the latter properties. Instead, Harlan (U.S. Pat. No. 3,239,478) teaches how “oil-tolerant” they can be, Korpman (U.S. Pat. No. 3,625,752) and Downey (U.S. Pat. Nos. 3,880,953 and 3,954,692) teach how to improve adhesion through use of specifically formulated tackifiers, and Freeman (U.S. Pat. No. 4,102,835) and Korpman (U.S. Pat. No. 4,136,071) use combinations of ABA and AB copolymers to extend the range of performance.

U.S. Pat. No. 4,554,324 (Husman et al.) discloses acrylate copolymer pressure sensitive adhesive compositions having A and C monomers and optionally, B monomers. The A monomers are alkyl acrylate monomers, the C monomers are macromonomers, and the optional B monomers are polar monomers copolymerizable with the A monomers.

Psa systems which by their nature are adhesives which have an extremely delicate balance of properties known in the trade as the “fourfold” balance of adhesion, cohesion, stretchiness and elasticity are described in U.S. Pat. No. 2,884,176. The desire to maintain this balance of properties makes it extremely difficult to improve internal strength, i.e., the cohesiveness without also upsetting the other properties and destroying the overall pressure-sensitive nature of the adhesive system.

The prior art relating to “graft” copolymers does not deal with psa systems. The prior art related to “graft” copolymers is directed to modifying systems which are not pressure-sensitive and for purposes diametrically opposed to the teaching of the present application. The patents of Behrens (U.S. Pat. No. 3,004,958), Gregorian (U.S. Pat. No. 3,135,717), Milkovich (U.S. Pat. Nos. 3,786,116; 3,832,423; 3,862,267) teach how to graft side chains of polystyrene or acrylate esters onto rigid or semi-rigid backbones of polyvinyl chloride or methacrylate polymers to provide flexibility and temperature and impact resistance. Harlan (U.S. Pat. No. 4,007,311) shows that grafting methyl methacrylate to a styreneisoprene-styrene block copolymer enhances adhesion without regard for elasticity or cohesiveness. In Ambrose (U.S. Pat. No. 4,075,186), a butadiene side chain is grafted to an acrylate polymer backbone to produce a molding material which has improved electrical properties and impact resistance but which is tack-free.

An acrylic psa having versatile processing capabilities and improved shear strength, to applicants' knowledge, is not known. Applicants herein teach the preparation of such an adhesive without sacrificing the outstanding optical clarity and resistance to oxidative and photochemical forces of the acrylic ester copolymer backbone.

### SUMMARY

The present invention relates to a polymerizable composition comprising a low T_{g} (meth)acrylate ester monomer, a high T_{g} macromer (macromonomer) and a polyfunctional, Norrish type I, photoinitiator. The resulting copolymers are physically crosslinked and are in many embodiments clear. The copolymers with greater than 20 percent macromer are clear films and less than 20% gave high performance pressure sensitive adhesives. These copolymers may be compounded with tackifiers and plasticizers that will influence the properties while lowering the melt viscosity into a desirable range. The invention provides significant property enhancements for copolymers having poor peel and shear adhesive properties. The acrylic backbone is tailored by judicious selection of acrylic co-monomers in order to allow compounding with additives that provide balanced adhesive properties while ensuring long term weatherbility and durability.

The pressure-sensitive adhesives of this disclosure provide the desired balance of tack, peel adhesion, and shear holding power, and further conform to the Dahlquist criteria; i.e. the modulus of the adhesive at the application temperature, typically room temperature, is less than 3×10⁶ dynes/cm at a frequency of 1 Hz. In particular, the instant adhesive compositions have high cohesive strength in the absence of crosslinking agents.

In some embodiments, adhesive compositions are provided which applied to substrates from the melt. Such hot melt adhesive compositions are substantially solvent-free. Hot melt adhesives are versatile and widely used in industrial applications, such as bookbindings, cardboard boxes, plastic parts and wooden articles, among others. They are generally 100% solid adhesives with application temperatures which vary from about 150 to about 180° C.

The adhesive compositions of the present disclosure provide an improved pressure-sensitive and hot-melt adhesive composition which may be adhered to a variety of substrates, including low surface-energy (LSE) substrates, within a wide temperature range and provide good adhesive strength and holding characteristics. The adhesive compositions are easily handled, and are environmentally friendly due to the low volatile organic compound (VOC) content, such as solvents. The adhesive compositions of the present disclosure further provide a pressure-sensitive adhesive article, such as adhesive tapes and sealants.

### DETAILED DESCRIPTION

The macromer (macromonomer) useful in the practice of this invention is a polymeric moiety having a vinyl group which will copolymerize with the alkyl (meth)acrylate monomer, and optional additional monomers. The macromonomer is represented by the general formula

X—(Y)ₙ—Z I

wherein X is a vinyl group copolymerizable with the alkyl (meth)acrylate and other optional monomers:
Y is a divalent linking group where n can be zero or one, and
Z is a monovalent polymeric moiety having a T_{g} greater than 20° C., a number average molecular weight in the range of about 2,000 to about 30,000, and being essentially unreactive under copolymerization conditions. Z is preferably selected from oligomeric styrene, methystyrene, poly(methyl methacrylate) and macromers of high T_{g} monomers, as describe further herein.

The preferred macromonomer is further defined as having an X group with the general formula

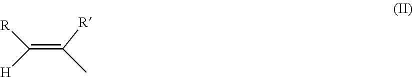

wherein R is a hydrogen atom and R′ is a hydrogen atom or methyl group. The double bond between the carbon atoms provides a moiety capable of copolymerizing with the alkyl acrylate and reinforcing monomers.

The preferred macromer includes a Z group which has the formula

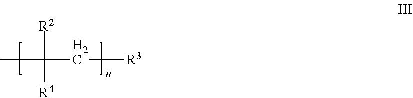

wherein R² is a hydrogen atom or a lower alkyl group, R³ is a lower alkyl group, n is an integer from 20 to 500, and R⁴ is a monovalent radical selected from the group consisting of aryl including substituted aryl and —CO₂R⁶ wherein R⁶ is a lower alkyl group.

Preferably, the macromer has the general formula selected from the group consisting of

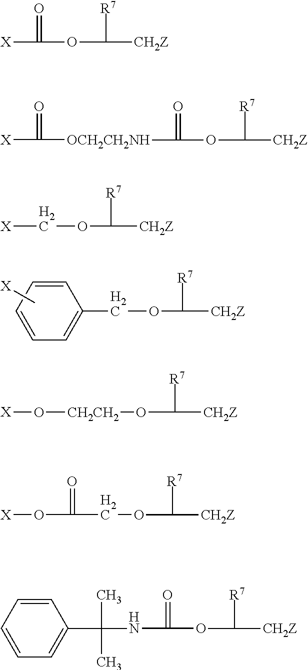

wherein R⁷ is a hydrogen atom or a lower alkyl group.

The vinyl-terminated polymeric macromonomers may be prepared by the method disclosed in U.S. Pat. Nos. 3,786,116 and 3,842,059 (Milkovich et al.), incorporated herein by reference.

In some embodiments the macromers of Formula I comprise homopolymerized high T_{g} monomers, i.e. the Z group comprises interpopolymerized high T_{g} monomers. The adhesive copolymer further comprises grafted monomer units of high T_{g} monomers or macromers. As used herein the term “high T_{g} monomer” refers to a monomer, which when homopolymerized, produce a (meth)acrylate copolymer having a T_{g} of ≥50° C. as estimated by the Fox equation. The incorporation of the high T_{g} monomer to copolymer is sufficient to provide glassy segments to the copolymer.

Suitable high T_{g} monomers include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

The amount of macromer that is useful varies from greater than about 1 to about 30 parts by weight per 100 parts by weight of the total amount by weight of the (meth)acrylate monomer, the optional additional polar monomers, and the macromer. In many embodiments 20 parts by weight or less of the macromer results in a pressure-sensitive adhesive composition. In such embodiments the PSA composition preferably comprises from about 1 parts to less than 20 parts and preferably, from about 5 parts to about 20 parts per 100 parts by weight of the total amount by weight of the (meth)acrylate monomer, the optional monomers, and the macromonomer.

Greater than 20 parts by weight results in optically clear coating compositions. In such embodiments the coating composition comprises greater than 20 to 30 parts by weight of the macromer, per 100 parts by weight of the total amount by weight of the (meth)acrylate monomer, the optional monomers, and the macromonomer

The curable composition comprises (meth)acrylic esters of a non-tertiary alcohol (acrylate esters), which alcohol contains from 1 to 20 carbon atoms and preferably an average of from 4 to 12 carbon atoms. A mixture of such monomers may be used. The acrylate ester monomer unit is represented as M^{acryl}.

The (meth)acrylate esters are generally selected from one or more low T_{g}(meth)acrylate monomers, having a T_{g} no greater than 10° C. when reacted to form a homopolymer. As used herein the term “low T_{g} monomer” refers to a monomer, which when homopolymerized, produce a (meth)acrylate polymer having a T_{g} of ≤10° C. as estimated by the Fox equation. In some embodiments, the low T_{g} monomers have a T_{g} no greater than 0° C., no greater than −5° C., or no greater than −10° C. when reacted to form a homopolymer. The T_{g} of these homopolymers is greater than or equal to −80° C., greater than or equal to −70° C., greater than or equal to −60° C., or greater than or equal to −50° C. The T_{g} of these homopolymers can be, for example, in the range of −80° C. to 10° C., −70° C. to 10° C., −60° C. to 0° C., or −60° C. to −10° C.

Exemplary low T_{g} monomers include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, and dodecyl acrylate.

Low T_{g} heteroalkyl acrylate monomers include, but are not limited to, 2-methoxyethyl acrylate and 2-ethoxyethyl acrylate.

In some embodiments, the preferred (meth)acrylate ester monomer is the ester of (meth)acrylic acid with an alcohol derived from a renewable source, such as 2-octanol, citronellol, dihydrocitronellol.

In some embodiments a portion of the above described (meth)acrylate esters may be substituted with (meth)acrylates derived from 2-alkyl alkanols (Guerbet alcohols) as described in U.S. Pat. No. 8,137,807 (Lewandowski et al.), incorporated herein by reference.

The (meth)acrylate ester monomer is present in an amount of ≥70 parts by weight based on 100 parts total curable composition. Preferably (meth)acrylate ester monomer is present in an amount of ≥80 parts by weight parts by weight, most preferably ≥90 parts by weight parts by weight, based on 100 parts total curable composition.

The monomer component of the curable composition may further comprise a polar monomer designated M^{polar}. The polar monomers useful in preparing the copolymer are both somewhat oil soluble and water soluble, resulting in a distribution of the polar monomer between the aqueous and oil phases in an emulsion polymerization. As used herein the term “polar monomers” are inclusive of acid functional monomers.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone.

The polar monomer of the copolymer may comprise an acid functional monomer, where the acid functional group may be an acid per se, such as a carboxylic acid, or a portion may be a salt thereof, such as an alkali metal carboxylate. With regard to Formula I, M^{polar} may be designated as M^{acid} when acid functional monomers are used

Useful acid functional monomers include, but are not limited to, those selected from ethylenically unsaturated carboxylic acids, ethylenically unsaturated sulfonic acids, ethylenically unsaturated phosphonic or phosphoric acids, and mixtures thereof.

Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

The polar monomer may be present in amounts of 0-10 parts by weight, preferably 0.1-5 parts by weight, based on 100 parts by weight total curable composition. With reference to the copolymer of Formula I, subscript c reflects these amounts, so c may be zero or non-zero, or a normalized, non-integral value.

The (meth)acrylate ester monomer, and the optional polar monomers are selected for and used in amounts such that the resulting copolymer has a T_{g} of <10° C., preferably less than 0° C., more preferably <−10° C., as estimated by the Fox Equation.

The curable composition further comprises a polyfunctional photoinitiator having two or more type I (alpha-cleavage) photoinitiator groups. The polyfunctional PI is of the formula:

R¹⁰-(PI)ₓ,

where
R¹⁰ is a polyvalent (hetero)hydrocarbyl group,
x is at least 2 and
PI is a photoinitiator represented by the structure:

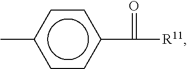

wherein R¹¹ is

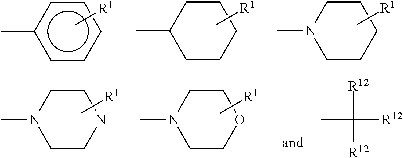

wherein R¹ is H or a C₁ to C₄ alkyl group,
each R¹² is independently a hydroxyl group, a phenyl group, a C₁ to C₆ alkyl group, or a C₁ to C₆ alkoxy group.

The polyfunctional photoinitiators can be made by reaction of: 1) (hetero)hydrocarbyl compound comprising two or more first reactive functional group with 2) a compound that comprises an alpha-cleavage photoinitiator group) and second reactive functional group, the two functional groups being co-reactive with each other. Preferred (hetero)hydrocarbyl compounds are aliphatic, cycloaliphatic, and aromatic compounds having up to 36 carbon atoms, optionally one or more oxygen and/or nitrogen atoms, and at least two reactive functional group. When the first and second functional groups react, they form a covalent bond and link the co-reactive compounds.

Examples of useful reactive functional groups include hydroxyl, amino, oxazolinyl, oxazolonyl, acetyl, acetonyl, carboxyl, isocyanato, epoxy, aziridinyl, acyl halide, and cyclic anhydride groups. Where the first reactive functional group is an isocyanato functional group, the second, co-reactive functional group preferably comprises a amino, carboxyl, or hydroxyl group. Where first reactive functional group comprises a hydroxyl group, the second, co-reactive functional group preferably comprises a carboxyl, isocyanato, epoxy, anhydride, acyl halide, or oxazolinyl group. Where the first reactive functional group comprises a carboxyl group, the second co-reactive functional group preferably comprises a hydroxyl, amino, epoxy, vinyloxy, or oxazolinyl group.

Representative examples of photoinitiator compounds include functional group-substituted compounds such as 1-(4-hydroxyphenyl)-2,2-dimethoxyethanone, 1-[4-(2-hydroxyethyl)phenyl]-2,2-dimethoxyethanone, (4-isocyanatophenyl)-2,2-dimethoxy-2-phenylethanone, 1-{4-[2-(2,3-epoxypropoxy)phenyl]}-2,2-dimethyl-2-hydroxyethanone, 1-[4-(2-aminoethoxy)phenyl]-2,2-dimethoxyethanone, and 1-[4-(carbomethoxy)phenyl]-2,2-dimethoxyethanone.

The curable composition may be polymerized by combining the components and irradiating, whereby the photoinitiator groups photolyze and initiate free radical addition/polymerization of the high T_{g} monomer/macromer.

Polymerization techniques include, but are not limited to, the conventional techniques of solvent polymerization, dispersion polymerization, and solventless bulk polymerization.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

If desired, the molecular weight, M_{w}, of the copolymer of Formula II may be controlled with the use of chain transfer agents. Chain transfer agents which may be used are mercapto compounds such as dodecylmercaptan and halogen compounds such as carbon tetrabromide.

In general, the component of the curable composition are combined and irradiated with activating UV radiation to photolyse the photoinitiator group and polymerize the monomers and macromer component(s) to produce the adhesive copolymer. The degree of conversion (of monomers or macromers to grafted copolymer) can be monitored during the irradiation by measuring the index of refraction of the polymerizing mixture.

UV light sources can be of two types: 1) relatively low light intensity sources such as backlights which provide generally 10 mW/cm² or less (as measured in accordance with procedures approved by the United States National Institute of Standards and Technology as, for example, with a Uvimap™ UM 365 L-S radiometer manufactured by Electronic Instrumentation & Technology, Inc., in Sterling, Va.) over a wavelength range of 280 to 400 nanometers and 2) relatively high light intensity sources such as medium pressure mercury lamps which provide intensities generally greater than 10 mW/cm², preferably between 15 and 450 mW/cm². For example, an intensity of 600 mW/cm² and an exposure time of about 1 second may be used successfully. Intensities can range from about 0.1 to about 150 mW/cm², preferably from about 0.5 to about 100 mW/cm^{Z}, and more preferably from about 0.5 to about 50 mW/cm^{Z}. Such photoinitiators preferably are present in an amount of from 0.1 to 1.0 pbw per 100 pbw of the polymer composition.

Due to the reduced reactivity of the macromer relative to the (meth)acrylate ester monomer, the macromer tends to be concentrated at the chain termini as in the formula:

R¹⁰-([R^{acryl}]ₐ-[R^{macro}]_{b})ₓ, II where

R¹⁰ is polyvalent (hetero)hydrocarbyl group and is the residue of the polyfunctional photoinitiator,
[R^{acryl}] is polymerized (meth)acrylate ester monomer units where subscript a is at least 70 parts by weight,
and
[R^{macro}] is polymerized macromer units and subscript b is 0.1 to 30 parts by weight.
In some embodiments the copolymer further comprises polymerized polar monomer units of the formula [R^{polar}]_{c}, where c is 0.1-10 parts by with to produce a copolymer of the formula

R¹⁰-([R^{acryl}]ₐ-[R^{polar}]_{c}-[R^{macro}]_{b})ₓ, III

As can be seen form the above formulas, the subscripts a, c and b are sufficiently large that the R¹⁰ group may be ignored. Simplified, the copolymer may be considered an A-Bₓ block copolymer where the A block are the low T_{g} (meth)acrylate ester/polar monomer copolymeric blocks and the B blocks are the high T_{g} blocks of the macromer and subscript x is at least 2, preferably 2 to 3.

If desired, the molecular weight, M_{w}, of the copolymer of Formula II may be controlled with the use of chain transfer agents. Chain transfer agents which may be used are mercapto compounds such as dodecylmercaptan and halogen compounds such as carbon tetrabromide.

In some embodiments the copolymer is of the formula:

R¹⁰-([R^{acryl}]ₐ-[R^{polar}]_{c}-[R^{macro}]_{b}-[R^{acryl}]ₐ-[R^{polar}]_{c})ₓ,

where each monomer unit is as previously described.

As result of the interpolymerized macromer units, the copolymer physically crosslinks. It is believed that the macromer groups phase separate from the main polymer chain. This phase separation results in the formation of separate domains of the macromer units that function as physical crosslinks for the (meth)acrylate copolymer chain. The copolymer can be used as an adhesive such as a pressure sensitive adhesive. The cohesive strength of the adhesive tends to increase with the introduction of more grafted groups.

Physical crosslinking typically relies on the natural or induced formation of entanglements within the grafted polymeric chains and tends to increase the cohesive strength of compositions such as pressure-sensitive adhesive compositions. Physical crosslinking is often desired because the pressure-sensitive adhesive can be processed in a melted state at relatively high temperatures yet can take on a crosslinked form at lower temperatures. That is, the pressure-sensitive adhesives can be used as hot melt adhesives. In contrast, chemical crosslinked pressure-sensitive adhesives typically cannot be processed as hot melt adhesives. Hot melt processing is often considered desirable because the use of inert organic solvents can be minimized or eliminated. The minimization or elimination of inert organic solvents can be desirable from both an environmental and economic perspective.

Physical crosslinking is enhanced when the macromer group has a glass transition temperature greater than or equal to at least 30° C. To form such a copolymeric group, the monomers used are selected to have a glass transition temperature equal to at least 30° C., preferably at least 50° C. (when polymerized as a homopolymer and as estimated by the Fox equation).

In addition to the glass transition temperature, the molecular weight of the macromer group can affect whether or not the copolymer of Formula I will phase separate and physically crosslink. Phase separation and entanglement is more likely if number of repeat units of a given grafted group is at least 10. It will be appreciated that the photoinitiated polymerization is essentially uncontrolled, and a range of repeat units (subscript e of Formula I) will be present. However, the copolymer of Formula I is prepared with a sufficient number of photoinitiator monomer units, and then copolymerized with a sufficient amount of macromers, such that the macromer groups will phase separate to effect physical crosslinking. Generally, at least 10% of the macromer groups have at least ten repeat units; at least ten percent of subscript e is ten or more, and is less than 50.

If the molecular weight of the macromer groups becomes too large (i.e. the number of repeat units is too large), the number of grafted polymer groups formed on a weight basis by reaction with the main polymer chain may be diminished. That is, as the molecular weight of the macromer increases, it can become more difficult to achieve a high degree of incorporation of macromer groups on a weight basis in the copolymer.

The pressure-sensitive adhesives may optionally contain one or more conventional additives. Preferred additives include tackifiers, plasticizers, dyes, antioxidants, UV stabilizers, and (e.g. inorganic) fillers such as (e.g. fumed) silica and glass bubbles. In some embodiments no tackifier is used. When tackifiers are used, the concentration can range from 5 or 10, 15 or 20 wt. % or greater of the (e.g. cured) adhesive composition.

Various types of tackifiers include phenol modified terpenes and rosin esters such as glycerol esters of rosin and pentaerythritol esters of rosin that are available under the trade designations “Nuroz”, “Nutac” (Newport Industries), “Permalyn”, “Staybelite”, “Foral” (Eastman). Also available are hydrocarbon resin tackifiers that typically come from C5 and C9 monomers by products of naphtha cracking and are available under the trade names “Piccotac”, “Eastotac”, “Regalrez”, “Regalite” (Eastman), “Arkon” (Arakawa), “Norsolene”, “Wingtack” (Cray Valley), “Nevtack”, LX (Neville Chemical Co.), “Hikotac”, “Hikorez” (Kolon Chemical), “Novares” (Rutgers Nev.), “Quintone” (Zeon), “Escorez” (Exxonmobile Chemical), “Nures”, and “H-Rez” (Newport Industries). Of these, glycerol esters of rosin and pentaerythritol esters of rosin, such as available under the trade designations “Nuroz”, “Nutac”, and “Foral” are considered biobased materials.

The above-described compositions are coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. These various methods of coating allow the compositions to be placed on the substrate at variable thicknesses thus allowing a wider range of use of the compositions. Coating thicknesses may vary, but coating thicknesses of 2-500 microns (dry thickness), preferably about 10 to 250 microns, are contemplated.

The substrate is selected depending on the particular application in which it is to be used. For example, the adhesive can be applied to sheeting products, (e.g., decorative graphics and reflective products), label stock, and tape backings. Additionally, the adhesive may be applied directly onto a substrate such as an automotive panel, or a glass window so that another substrate or object can be attached to the panel or window.

The adhesive can also be provided in the form of an adhesive transfer tape in which at least one layer of the adhesive is disposed on a release liner for application to a permanent substrate at a later time. The adhesive can also be provided as a single coated or double coated tape in which the adhesive is disposed on a permanent backing.

### Examples

### Materials

| Designation | Description |
|---|---|
| n-BA | n-Butyl acrylate, available from Alfa Assar, Ward Hill, MA. |
| AA | Acrylic acid, available from Sigma Aldrich, St. Louis, MO. |
| Mf1PI | A monofunctional, UV light activated photoinitiator, 2-hydroxy-1-[4- |
| | (2-hydroxyethoxy)phenyl]-2-methyl-propan-1-one, available under |
| | trade designation of IRGACURE 2959, BASF Corporation, Florham Park, NJ. |
| Pf2PI | A difunctional, UV light activated photoinitiator, 2-[4-(2-hydroxy-2- |
| | methyl-propanoyl)phenoxy]ethyl N-[6-[2-[4-(2-hydroxy-2-methyl |
| | propanoyl)phenoxy]ethoxycarbonylamino]hexyl]carbamate, prepared |
| | as described below. |
| Pf3PI-A | A trifunctional, UV light activated photoinitiator, 2-[4-(2-hydroxy-2- |
| | methyl-propanoyl)phenoxy]ethyl N-[6-[3,5-bis[6-[2-[4-(2-hydroxy- |
| | 2-methyl-propanoyl)phenoxy]ethoxycarbonylamino]hexyl]-2,4,6- |
| | trioxo-1,3,5-triazinan-1-yl]hexyl]carbamate, prepared as described below. |
| Pf3PI-B | A trifunctional, UV light activated photoinitiator, tris[2-[4-(2- |
| | hydroxy-2-methyl-propanoyl)phenoxy]ethyl] benzene-1,3,5- |
| | tricarboxylate, prepared as described below. |
| N3300 | A solvent free, polyfunctional, aliphatic isocyanate resin based |
| | hexamethylene diisocyanate (HDI) having an equivalent weight of |
| | approximately 193, an NCO content of 21.8%, and a monomeric HDI |
| | content of 0.2% maximum, available under the trade designation |
| | DESMODUR N3300A Covestro LLC, Pittsburgh, PA. |
| IOTG | Isooctyl Thioglycolate, a chain transfer agent, available from TCI |
| | America, Portland, OR. |
| E1010 | A poly(methacrylate) macromer which was determined by gel |
| | permeation chromatography (GPC) to have a weight average |
| | molecular weight of approximately 6770 grams/mole, obtained under |
| | the trade designation ELVACITE 1010 MACROMER from Lucite |
| | International, Cordova, TN. |
| PET Film | A polyester film, primed on one side and having thickness of 50 |
| | micrometers (0.002 inches), available under the trade designation |
| | HOSTAPHAN 3SAB, available from Mitsubishi Polyester Film, |
| | Incorporated, Greer, SC. |
| DBTDL | Dibutyltin dilaurate (DBTDL), a liquid catalyst, available under the |
| | trade designation DABCO T-12 from Air Products and Chemicals, |
| | Incorporated, Allentown, PA. |

### Test Methods

### Peel Adhesion Strength

Peel adhesion strength was measured according to ASTM D3330/D3330M-04: “Standard Test Method for Peel Adhesion of Pressure Sensitive Tape” (Reapproved 2010). After conditioning for 24 hours at 23° C. (73° F.) and 50% relative humidity (RH), tape samples measuring 12.7 millimeters (0.5 inches) wide and 20.3 centimeters (8 inches) long were cut. The tape samples were then applied to a glass plate previously wiped clean with methyl ethyl ketone (MEK), then n-heptane, and again with MEK. The tape was rolled down twice in each direction using a 2 kilogram (4.4 pounds) rubber roller. After a 30 minute dwell time the angle peel adhesion strength was measured, under the same temperature and relative humidity as used above, at an angle of 180 degrees, a rate of 305 millimeters/minute (12 inches/minute), and over a length of 5.1 centimeters (2 inches) using a peel adhesion tester (IMASS Slip/Peel Tester, Model SP-2000, available from IMASS Incorporated, Accord, MA). Three samples were evaluated, the results normalized to ounces/inch (oz/in) and the average value calculated and reported in Newtons/decimeter (N/dm). The failure mode was also recorded.

### Shear Strength—Room Temperature

Shear strength at 23° C. and 50% relative humidity (RH) was measured according to ASTM D3654/D 3654M-06: “Standard Test Methods for Shear Adhesion of Pressure Sensitive Tapes” (Reapproved 2011). After conditioning for 24 hours at 23° C. (73° F.) and 50% relative humidity, tape samples measuring 12.7 millimeters (0.50 inches) wide and 15.2 centimeters (6 inches) long were cut. The tape samples were then applied to a stainless steel panel previously wiped clean with methyl ethyl ketone (MEK), then n-heptane, and again with MEK. The samples were then centered on the panels and adhered to one end such that tape overlapped the panel by 25.4 millimeters (1 inch) in the lengthwise direction. The tape sample was then rolled down twice in each direction using a 2 kilogram (4.4 pounds) rubber roller.

A 1.0 kilogram (2.2 pounds) weight was then attached to the free end of the tape, and the panel/tape/weight assembly was suspended in a stand. The time, in minutes, for the tape to fall from the panel was recorded along with the mode of failure. The test was terminated if failure had not occurred in 10,000 minutes and the result recorded as “10,000+”. The average of two samples was reported.

### Shear Strength—Elevated Temperature

Shear strength was evaluated in the same manner as described for room temperature testing with the following modifications. A weight of 0.5 kilogram (1.1 pounds) was used and the panel/tape/weight assembly was suspended in a stand located in an oven set at 70° C. (158° F.).

### Dynamic Mechanical Analysis (DMA)

DMA was used to determine the storage modulus and glass transition temperature values of adhesive compositions. A sample of a pressure sensitive adhesive was folded over on itself several times to provide a total thickness of approximately 1 millimeter. A circular disk measuring 8 millimeters in diameter was cut out and transferred onto the bottom plate of a Model ARES G2 RHEOMETER (TA Instruments, New Castle, Del.). The rheometer had parallel top and bottom plates each having a diameter of 8 millimeters. The top plate of the rheometer was brought down onto the sample of adhesive composition. A temperature sweep was run from −60° C. to 200° C. at a rate of 5° C./minute using the following parameters: strain amplitude of 1%, frequency of 1 Hertz. Shear modulus (G′) and loss modulus (G″) were determined as a function of temperature and the ratio of (G″/G′) was used to calculate tan delta. The peak of the tan delta curve was taken as the glass transition temperature (T_{g}). The shear modulus (G′) values in KiloPascals (KPa) at 25° C. and the glass transition temperature values (° C.) were reported.

### Gel Permeation Chromatography (GPC)

Molecular weights and polydispersity were determined at 23° C. by gel permeation chromatography (GPC) using a Model AGILENT 1100 Series LC SYSTEM (Agilent Technologies, Santa Clara, Calif.) equipped with a JORDI Gel DVB (Divinyl Benzene) MB-LS (Mixed Bed-Light Scattering) 250 millimeter (length)×10 millimeter I.D. (Inside Diameter) column set, in combination with a Model WYATT REX DIFFERENTIAL REFRACTIVE INDEX DETECTOR and a Model WYATT HELEOS II 18 ANGLE STATIC LIGHT SCATTERING DETECTOR (Wyatt Technology Corporation, Santa Barbara, Calif.). Sample solutions were prepared by adding 10 milliliters of tetrahydrofuran (THF) to a sample weighing between approximately 50 and 100 milligrams, and mixing for at least 14 hours followed by filtering through a 0.2 micrometer polytetrafluoroethylene syringe filter. The injection volume was 30 microliters and the THF eluent flow rate was 1.0 milliliter/minute. Duplicate solutions were run. The results were analyzed using Wyatt ASTRA software, Version 5.3. Weight and Number Average Molecular Weights (Mw and Mn) were reported in grams/mole, along with polydispersity (Mw/Mn).

### % Transmission/% Haze/L*, a*, and b*

Film samples were cut to approximately 10 centimeters in length and 5 centimeters in width. After removal of the release liner the samples were evaluated for haze, transmission, L*, a*, and b* properties using a Model ULTRASCAN PRO SPECTROPHOTOMETER with D65 standard illuminant (Hunter Associates Laboratory, Incorporated, Reston, Va.) in transmission mode from 350 to 850 nanometers. Results for % Haze, L*, a*, and b* as well as the average % Transmission between 400 and 700 nanometers were reported. For optical applications, desirable properties include a luminous transmission of greater than about 90 percent and a haze of less than about 2 percent in the 400 to 700 nanometer wavelength range.

### Preparation of Pf2PI

To a solution containing 8.4 grams of 1,6-hexane diisocyanate (Sigma Aldrich, St. Louis Mo.) and 22.4 grams of Mf1PI in 75 milliliters of methyl ethyl ketone was added a few drops of DBTDL. The reaction mixture was heated at reflux overnight and then concentrated under reduced pressure to give a first white solid. The first white solid was dissolved in 125 milliliters of hot ethanol then 25 milliliters of water was added. The solution was cooled in a dry ice bath to give a second white solid which was isolated by filtration. Crystallization of the second white solid from methyl ethyl ketone gave 21.3 grams of 2-[4-(2-Hydroxy-2-methyl-propanoyl)phenoxy]ethyl N-[6-[2-[4-(2-hydroxy-2-methyl-propanoyl)phenoxy]ethoxycarbonylamino]hexyl]carbamate (herein referred to as Pf2PI) as a white solid. Proton NMR (CDCl3) results: □ (delta) 8.06 (d, J=8.8 Hz, 4H), 6.94 (d, J=8.8 Hz, 4H), 4.97 (m, 2H), 4.42 (m, 4H), 4.29 (s, 2H), 4.21 (m, 4H), 3.16 (m, 4H), 1.61 (m, 12H), 1.48 (m, 4H), 1.32 (m, 4H).

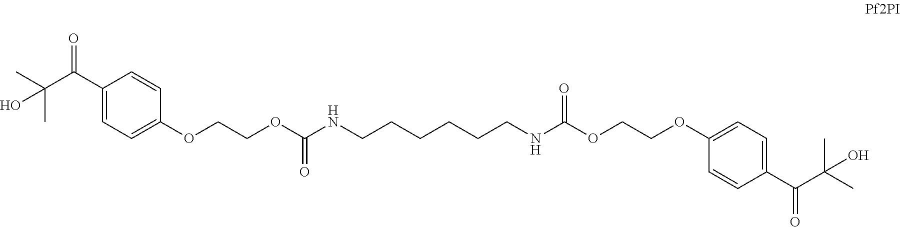 [SMILES: CC(C)(O)C(=O)c1ccc(OCCOC(=O)NCCCCCCNC(=O)OCCOc2ccc(C(=O)C(C)(C)O)cc2)cc1]

### Preparation of Pf3PI-A

To a magnetically stirred solution containing 2.01 grams of N3300 dissolved in 50 milliliters of dry toluene in a round bottomed flask was added 2.36 grams of Mf1PI in a single portion. After stirring for three days at ambient temperature (22-25° C.) the reaction mixture was concentrated under reduced pressure to give a white syrup. This syrup was purified by column chromatography using silicon dioxide column and a solvent gradient of 2.5% methanol/chloroform to 10% methanol/chloroform) then concentrated several times from hexanes to give 1.88 grams of 2-[4-(2-hydroxy-2-methyl-propanoyl)phenoxy]ethyl N-[6-[3,5-bis[6-[2-[4-(2-hydroxy-2-methyl-propanoyl)phenoxy]ethoxycarbonylamino]hexyl]-2,4,6-trioxo-1,3,5-triazinan-1-yl]hexyl]carbamate (herein referred to as Pf3PI-A) as a crusty white solid. Proton NMR (CDCl3) results: 0 (delta) 8.06 (d, J=8.8 Hz, 6H), 6.94 (d, J=8.8 Hz, 6H), 4.97 (m, 3H), 4.42 (m, 6H), 4.30 (s, 3H), 4.21 (m, 6H), 3.84 (m, 6H), 3.16 (m, 6H), 1.62 (m, 24H), 1.50 (m, 6H), 1.34 (m, 12H).

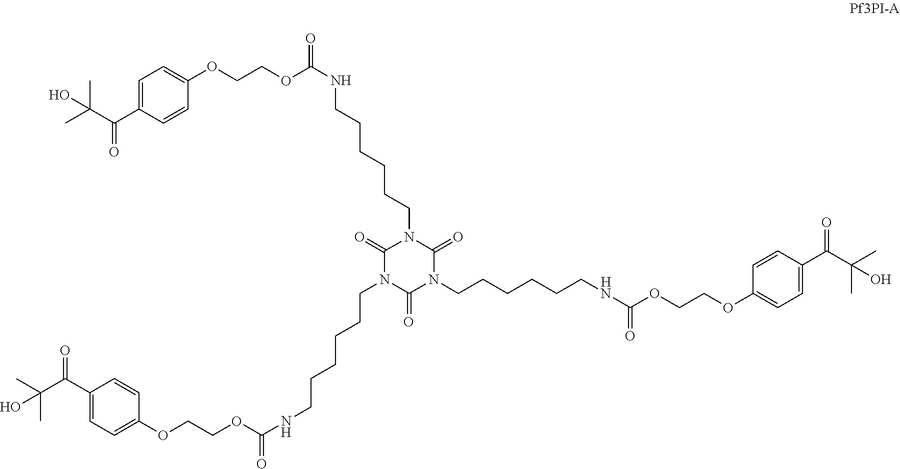

Preparation of Pf3PI-B An oven dried 1 liter round bottom flask equipped with a magnetic stirrer was charged with trimesoyl chloride (13.6 grams, 51.2 millimoles) and 300 milliliters of methylene chloride. The mixture was stirred and cooled in an ice bath under a nitrogen atmosphere. Next, 34.7 grams (155 millimoles) of Mf1PI was added in portions over a few minutes with continued stirring. Pyridine, 13.8 milliliters (171 millimoles) was then slowly added over a period of 5 minutes followed by addition of 500 milligrams of N,N-dimethylaminopyridine in a single portion. The reaction mixture was allowed to warm to ambient temperature overnight with stirring maintained. A majority of the methylene chloride was removed under reduced pressure and the resulting syrup was dissolved in 400 milliliters of ethyl acetate. This was washed successively with 200 milliliters of 1N hydrochloric acid, three times with 200 milliliters of water, and finally with 200 milliliters of brine. The organic phase was dried over sodium sulfate, filtered and concentrated to give a white solid. Recrystallization from ethanol gave 38.1 grams of tris[2-[4-(2-hydroxy-2-methyl-propanoyl)phenoxy]ethyl] benzene-1,3,5-tricarboxylate (herein referred to as Pf3PI-B) as a white powder. ¹H NMR (500 MHz, CDCl3) □□ (delta) 8.87 (s, 3H), 8.07 (m, 6H), 6.98 (m, 6H), 4.76 (m, 6H), 4.42 (m, 6H), 1.62 (s, 18H).

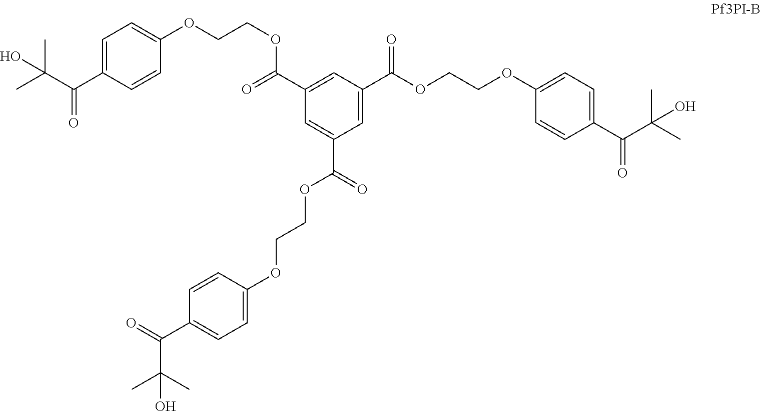 [SMILES: CC(C)(O)C(=O)c1ccc(OCCOC(=O)c2cc(C(=O)OCCOc3ccc(C(=O)C(C)(C)O)cc3)cc(C(=O)OCCOc3ccc(C(=O)C(C)(C)O)cc3)c2)cc1]

### Preparation of Base Pressure Sensitive Adhesive (PSA) Polymer Solutions

Solutions of PSA copolymers were prepared by UV light initiated free radical polymerization using the materials and amounts shown in Table 1. The total amount of monomers was 100 parts by weight (pbw), the MF1PI, Pf2PI, and IOTG amounts were added in parts per one hundred part of monomers (pph), and the amount of ethyl acetate was in pbw. The materials were added to a 250 milliliter clear bottle. The solution was stirred at room temperature until the E1010 had dissolved then purged with nitrogen gas for 15 minutes. The bottle was then sealed and placed on a roller under low intensity UV light from two 40 Watt Sylvania 350 Blacklight bulbs (peak emission of approximately 350 nanometers) for 4 hours to provide a total UVA energy of 28.8 Joules/square centimeter. The resulting polymer solution was analyzed using GPC then used to prepare pressure sensitive adhesive tapes which were further evaluated as described below. The GPC results are shown in Table 2.

TABLE 1
Base PSA Polymer Solution (PS) Compositions

| | nBA | AA | E1010 | Mf1PI | Pf2PI | Pf3PI-A | Pf3PI-B | IOTG | Ethyl Acetate |
|---|---|---|---|---|---|---|---|---|---|
| Ex. | (pbw) | (pbw) | (pbw) | (pph) | (pph) | (pph) | (pph) | (pph) | (pbw) |
| PS C1 | 100.0 | 0.0 | 0.0 | 0.0 | 0.2 | 0.0 | 0.0 | 0.0 | 200 |
| PS C2 | 95.0 | 5.0 | 0.0 | 0.0 | 0.2 | 0.0 | 0.0 | 0.0 | 200 |
| PS C3 | 0.0 | 0.0 | 100 | 0.0 | 0.2 | 0.0 | 0.0 | 0.0 | 100 |
| PS 1 | 90.0 | 0.0 | 10.0 | 0.0 | 0.2 | 0.0 | 0.0 | 0.0 | 200 |
| PS 2 | 80.0 | 0.0 | 20.0 | 0.0 | 0.2 | 0.0 | 0.0 | 0.0 | 200 |
| PS 3 | 70.0 | 0.0 | 30.0 | 0.0 | 0.2 | 0.0 | 0.0 | 0.0 | 200 |
| PS 4 | 85.5 | 4.5 | 10.0 | 0.0 | 0.2 | 0.0 | 0.0 | 0.0 | 200 |
| PS 5 | 76.0 | 4.0 | 20.0 | 0.0 | 0.2 | 0.0 | 0.0 | 0.0 | 200 |
| PS 6 | 66.5 | 3.5 | 30.0 | 0.0 | 0.2 | 0.0 | 0.0 | 0.0 | 200 |
| PS 7 | 80.0 | 0.0 | 20.0 | 0.0 | 0.2 | 0.0 | 0.0 | 0.1 | 100 |
| PS 8 | 80.0 | 0.0 | 20.0 | 0.14 | 0.0 | 0.0 | 0.0 | 0.1 | 100 |
| PS 9 | 95.0 | 0.0 | 5.0 | 0.0 | 0.2 | 0.0 | 0.0 | 0.0 | 200 |
| PS 10 | 95.0 | 0.0 | 5.0 | 0.14 | 0.0 | 0.0 | 0.0 | 0.0 | 200 |
| PS 11 | 95.0 | 0.0 | 5.0 | 0.0 | 0.0 | 0.2 | 0.0 | 0.0 | 100 |
| PS 12 | 95.0 | 0.0 | 5.0 | 0.0 | 0.0 | 0.0 | 0.2 | 0.0 | 100 |
| PS 13 | 85.5 | 4.5 | 10 | 0.0 | 0.0 | 0.2 | 0.0 | 0.0 | 100 |
| PS 14 | 85.5 | 4.5 | 10 | 0.0 | 0.0 | 0.0 | 0.2 | 0.0 | 100 |
| Control | 0.0 | 0.0 | 100 | 0.0 | 0.0 | 0.0 | 0.0 | 0.0 | 0.0 |

TABLE 2
GPC Results

| Ex. | Mn | Mw | Polydispersity |
|---|---|---|---|
| PS C1 | 512,000 | 1,050,000 | 2.06 |
| PS C2 | 589,000 | 1,060,000 | 1.81 |
| PS C3 | 4,040 | 6,540 | 2.75 |
| PS 1 | 422,000 | 939,000 | 2.23 |
| PS 2 | 305,000 | 807,000 | 2.65 |
| PS 3 | 328,000 | 895000 | 2.75 |
| PS 4 | 476,000 | 988,000 | 2.08 |
| PS 5 | 325,000 | 774,000 | 2.38 |
| PS 6 | 449,000 | 1,120,000 | 2.49 |
| PS 7 | 295,000 | 872,000 | 2.96 |
| PS 8 | 105,000 | 277,000 | 2.65 |
| PS 9 | 265,000 | 975,000 | 3.68 |
| PS 10 | 115,000 | 261,000 | 2.27 |
| PS 11 | 253000 | 695800 | 2.75 |
| PS 12 | 322700 | 529600 | 1.64 |
| PS 13 | 92000 | 191400 | 2.08 |
| PS 14 | 122300 | 254100 | 2.08 |
| Control | 4,490 | 6,770 | 1.51 |

A comparison of PS C₃ (macromer and difunctional photoinitiator) with the Control indicates the presence of difunctional photoinitiator (Pf2PI) did not appear to have a significant effect on the molecular weight. When a second acrylic monomer was present, such as butyl acrylate then the use of difunctional photoinitiator resulted in an increased molecular weight (see Examples 1 to 6, Ex. 7 vs 8 and Ex. 9 vs 10). The samples PS 11 to PS 14 may have some microgelation that is effecting the GPC results.

preparation of Pressure Sensitive Adhesive Tapes

Pressure sensitive adhesive tapes were prepared using the polymer solutions described above (i.e., Polymer Solution 1 was used to prepare Adhesive Tape 1, Polymer Solution 2 was used to prepare Adhesive Tape 2, and so on) as follows. The polymer solutions were coated onto the primed side PET Film using a knife coater having a gap setting that was 0.007 inches (178 micrometers) greater than the film thickness then dried for 30 minutes at 70° C. (158° F.) to provide pressure sensitive adhesive tapes. These were evaluated for their Peel Adhesion Strength, Shear Strength, Storage Modulus, and Glass Transition Temperature. The results are shown in Tables 3 and 4.

TABLE 3
Peel Adhesion Strength and Shear Strength

| | Peel Adhesion | Shear Strength | Shear Strength | Adhesive |
|---|---|---|---|---|
| | Strength* | at 23° C.* | at 70° C.* | Thickness |
| Ex. | (N/dm) | (minutes) | (minutes) | (micrometers) |
| C1 | 15 | 13 | 11 | 45.7 |
| C2 | 44 | 183 | 78 | 40.6 |
| 1 | 44 | 10000+ | 594 | 38.1 |
| 2 | 27 | 10000+ | 8826 | 40.6 |
| 3 | ** | ** | ** | 40.6 |
| 4 | 64 | 10000+ | 954 | 38.1 |
| 5 | 57 | 10000+ | 7823 | 43.2 |
| 6 | ** | ** | ** | 40.6 |
| 7 | 34 | 10000+ | 415 | 45.7 |
| 8 | 32 | 10000+ | 48 | 40.6 |
| 9 | 46 | 393 | 6 | 40.6 |
| 10 | 55 | 6 | 1 | 38.1 |
| 11 | 49 | 166 | ND | 37.5 |
| 12 | 46 | 203 | ND | 42.5 |
| 13 | 76 | 3650 | ND | 40.0 |
| 14 | 21 | 3230 | ND | 37.5 |

ND: not determined
*All shear failures were cohesive. All peel failures were adhesive except for Ex. 10 which was cohesive.
** the coated polymer solution of the tape article was transparent and tack free and therefore not tested.

The copolymers with E1010 macromer composition about 5% have little effect on the shear strength regardless of the nature of the multifunctional photoinitiator. (Ex. 9, 11, 12).
However, the shear strength of copolymer prepared from monofunctional initiator (Ex. 10) at 5% E1010 macromer is inferior to that of copolymers prepared with multifunctional initiators (Ex. 9, 11, 12).

TABLE 4
Glass Transition Temperatures and Shear Moduli

| | G′ | | G′ G″ |
|---|---|---|---|
| Ex. | @25° C. | Tg (° C.) | Crossover |
| 1 | 86 | −27 | 15015 |
| 2 | 250 | −11 | 119 |
| 3 | 2004 | 16 | 103 |
| 4 | 160 | −13 | 137 |
| 5 | 320 | 1 | 125 |
| 6 | 6302 | 30 | 103 |

G′ G″ crossover temperatures correlates with temperature above which the adhesive begins to flow. Generally, chemical crosslinked adhesives do not have a G′-G″ crossovers whereas physically crosslinked materials show such crossovers.
The presence of G′ G″ crossover in Examples 1-6 suggests that the materials are physically crosslinked.
Presence of physical crosslinking and higher modulus manifests in higher shear holding strength of the adhesives.

### Preparation of Coated Films

PSA Polymer Solutions 3 and 6 were used to prepare coated film samples for evaluation of optical properties as follows. Each solution was coated onto a silicone treated polyester release liner using a coating square to provide a wet coating thickness of 0.005 inches (126 micrometers) then dried for 30 minutes at 70° C. (158° F.) to provide a tack free film. The coated films were evaluated for % Transmission/% Haze/L*, a*, and b* as described in the test methods above. The results are shown in Table 5.

TABLE 5
Optical Properties

| | Polymer | Film Thickness | | | | | |
|---|---|---|---|---|---|---|---|
| Ex. | Solution | (micrometers) | L* | a* | b* | % Transmission | % Haze |
| Control: | NA | NA | 100.01 | 0.01 | 0 | 100.1 | 0 |
| Air | | | | | | | |
| 15 | 3 | 40.6 | 97.13 | 0.02 | 0.13 | 92.72 | 0.51 |
| 16 | 6 | 40.6 | 97.12 | 0.02 | 0.14 | 92.69 | 0.59 |

NA: not applicable

What is claimed is:

1. A polymerizable polymer composition comprising:
a) a copolymerizable macromer;
b) a (meth)acrylate ester monomer; and
c) a polyfunctional type I photoinitiator.

2. The polymer composition of claim 1 wherein the polyfunctional PI is of the formula:
R¹⁰-(PI)ₓ,
where
R¹⁰ is a polyvalent (hetero)hydrocarbyl group,
x is at least 2 and
PI is a photoinitiator which may be represented by the structure: 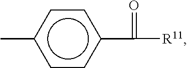
wherein R¹¹ is 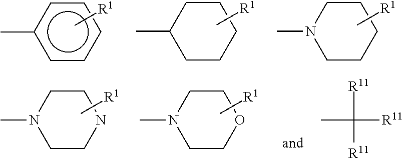
wherein R¹ is H or a C₁ to C₄ alkyl group,
each R¹¹ is independently a hydroxyl group, a phenyl group, a C₁ to C₆ alkyl group, or a C₁ to C₆ alkoxy group.

3. The composition of claim 1 wherein the macromer of the formula
X—(Y)ₙ—Z
wherein X is a vinyl group copolymerizable with the alkyl acrylate and reinforcing monomers;
Y is a divalent linking group where n can be zero or one, and Z is a monovalent polymeric moiety having a T_{g} greater than 20° C., and a molecular weight in the range of about 2,000 to 30,000.

4. The composition of claim 1 wherein X is of the general formula
RH═R¹—
wherein R is a hydrogen atom or a and R′ is a hydrogen atom or methyl group.

5. The composition of claim 1 wherein Z is of the general formula 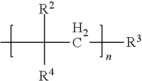
wherein R² is a hydrogen atom or a lower alkyl group, R³ is a lower alkyl group, n is an integer from 20 to 500, and R⁴ is a monovalent radical selected from the group consisting of aryl including substituted aryl and —CO₂R⁶ wherein R⁶ is a lower alkyl group.

6. The composition of claim 1 comprising:
a) 1 to 30 parts by weight of a copolymerizable macromer;
b) 70 to 99 parts by weight of a (meth)acrylate ester monomer; and
wherein a)+b) is 100 parts by weight.

7. The composition of claim 1 wherein the meth)acrylate ester monomer comprises a C₁-C₈ (meth)acrylate.

8. The composition of claim 7 further comprising a polar monomer.

9. The composition of claim 8 wherein the solvent monomer comprises a multifunctional (meth)acrylate.

10. A copolymer of the formula
R¹⁰-([R^{acryl}]ₐ-[R^{macro}]_{b})ₓ, where
R¹⁰ is polyvalent (hetero)hydrocarbyl group,
[R^{acryl}] is polymerized (meth)acrylate ester monomer units where subscript a is at least 70 parts by weight;
and
[R^{macro}] is polymerized macromer units and subscript b is 0.1 to 30 parts by weight, wherein a+b is 100 parts by weight.

11. The copolymer of claim 10 further comprising polymerized polar monomer units to provide a copolymer of the formula R¹⁰-([R^{acryl}]ₐ-[R^{polar}]_{c}-[R^{marco}]_{b})ₓ, where
R¹⁰ is polyvalent (hetero)hydrocarbyl group,
[R^{acryl}] is polymerized (meth)acrylate ester monomer units where subscript a is at least 70 parts by weight;
[R^{macro}] is polymerized macromer units and subscript b is 0.1 to 30 parts by weight,
[R^{polar}]_{c}, is polymerized polar monomer units wherein subscript c is 0.1 to 10 parts by weight wherein a+b+c is 100 parts by weight.

13. An A-Bₓ block copolymer where the A block are the low T_{g} (meth)acrylate ester/polar monomer copolymeric blocks and the B blocks are the high T_{g} blocks of the macromer and subscript x is at least 2, preferably 2 to 3.
